(19) United States
(12) Patent Application Publication
(10) Pub. No.: US 2003/0126006 A1
(43) Pub. Date: Jul. 3, 2003

(54) Method and apparatus for promoting use of a financial product

(76) Inventors: Neeraj Kumar, Bangalore (IN); Muthu Kumar, Bangalore (IN); John F. Wysaski, Plano, TX (US)

Correspondence Address: BUCKLEY, MASCHOFF, TALWALKAR, & ALLISON, 5 ELM STREET, NEW CANAAN, CT, 06840, US

(21) Appl. No.: 10/036,286

(22) Filed: Dec. 31, 2001

(51) Int. Cl. G06F 17/60

(52) U.S. Cl. 705/10

(57) ABSTRACT

A system, method, apparatus, means, and computer program code for efficiently promoting use of a financial product (e.g., credit card). According to embodiments of the present invention, an entity may receive information regarding past responses by recipients of one or more prior promotional communications. From this and other data regarding the recipients, statistically significant variables can be determined that can be used to indicate future responses by potential recipients of other promotional communications and likelihood of obtaining a desired response from different groups of recipients.

### CROSS-REFERENCE TO RELATED INVENTION

This patent application is related to co-pending U.S. patent application entitled Method and Apparatus for Determining an Offer Regarding a Financial Product, patent application Ser. No. ______ (Attorney Docket Number G07-011), filed simultaneously herewith, the contents of which are incorporated herein by reference.

### FIELD OF THE INVENTION

The present invention relates to a method and apparatus for promoting use of a financial product and, more particularly, embodiments of the present invention relate to methods, means, apparatus, and computer program code for selecting recipients of communications regarding financial products.

### BACKGROUND OF THE INVENTION

A seller or provider of a financial product typically wants holders of the financial product to increase use of the financial product. For example, an issuer of a credit card may make money from merchants from each transaction made by a customer with the merchants using the credit card. In addition, the issuer may be able to charge interest to the customer if the customer maintains a balance due with the credit card. In order to increase the use of issued credit cards by customers, the issuer may send out promotional communications (e.g., advertisements, letters) offering special deals, reminding customers of the benefits of their credit card, etc. Due to the labor, financial, and other costs associated with providing promotional communications to customers, the issuer may want to target the promotional communications to the most receptive customers, i.e., those customers who are most likely to increase their level of use of the credit card as a result of receiving the promotional communication.

It would be advantageous to provide a method, means, computer code and apparatus that allowed an entity providing a financial product to identify recipients of promotional communications that might be the most receptive to the promotional communications. In particular, it would be desirable to provide a method, means, computer code and apparatus that allowed an entity providing a financial product to identify recipients of promotional communications that are the most likely to conduct a designated or desired activity upon receiving the promotional communications.

### SUMMARY OF THE INVENTION

Embodiments of the present invention provide a system, method, apparatus, means, and computer program code for allowing an entity to identify recipients of promotional communications regarding financial product that are the most receptive to the promotional communications or that will be the most likely to complete a designated or desired activity upon receiving the promotional communications. For example, an entity sending a promotional communication to a group of recipients may want the recipients to increase their level of use of a credit card. The promotional communication may be sent as part of a marketing or promotional campaign for the credit card. Different communications may be used for different financial products. In addition, different communications may make different offers to recipients of the communications regarding one or more financial products.

A promotional communication may make or provide an offer to a recipient regarding a financial product. For example, an offer may provide a ten percent discount on all purchases made via a credit card, a ten percent discount on all purchases made during a specific time period, a ten percent discount on all purchases made at a specific merchant, an opportunity to renew a credit card, an opportunity to receive a new credit card, etc. Prior to sending a new promotional communication regarding a financial product, an entity may receive information regarding past responses or activities by recipients of one or more prior promotional communications. From this and other data regarding the recipients, statistically significant variables can be determined that can be used to indicate future responses by potential recipients of other promotional communications and the likelihood of obtaining a desired response from different groups of recipients. From this, segments of recipients can be identified and prioritized to receive the new promotional communication.

A financial product may include a credit card or debit card issued by a bank or other entity. In some embodiments, a financial product may be a credit card or debit card branded or private labeled with a logo of a merchant, advertiser, sports organization, bank or other financial institution, etc. The term “product” as used herein shall also include services that may be provided by the manager or other entity to potential and/or actual recipients of communications.

A communication may be or include any type of advertising, promotional or marketing material, message, etc. The communication may comprise, be sent in, or be part of an email message, instant message communication, banner or other electronic or Web based advertisement, letter, postcard, flyer, document, paper, coupon, facsimile transmission, beeper or pager signal or transmission, HTTP, FTP, XML or HTML transmission or feed, some other electronic signal or communication, etc.

Additional objects, advantages, and novel features of the invention shall be set forth in part in the description that follows, and in part will become apparent to those skilled in the art upon examination of the following or may be learned by the practice of the invention.

According to embodiments of the present invention, a method for identifying recipients of a communication regarding a financial product may include determining a plurality of segments from a plurality of potential recipients of a communication regarding a financial product, wherein each of the plurality of segments includes at least one member of the plurality of potential recipients and has an associated response rate, wherein a segment's associated response rate is indicative of a member of the segment exhibiting a designated behavior after receiving the communication; determining at least one criterion associated with the communication regarding a financial product; and determining at least one of the plurality of segments that may be used to satisfy the at least one criterion. In another embodiment, a method for providing a communication regarding a financial product may include providing a first communication regarding a financial product to a plurality of recipients; determining a plurality of segments of the plurality of recipients, wherein each of the plurality of segments includes at least one of the plurality of recipients; determining at least one criterion associated with a second communication regarding the financial product; determining at least one of the plurality of segments needed to satisfy the at least one criterion; and providing the second communication to at least one member of the determined at least one of the plurality of segments. In a further embodiment, a method for promoting a financial product may include providing a first communication regarding a financial product to a plurality of recipients; determining a plurality of segments, wherein each of the plurality of segments includes at least one member of the plurality of recipients and has an associated indicative characteristic, wherein a segment's associated indicative characteristic is indicative of a member of the segment exhibiting a designated behavior after receiving the first communication; determining at least one criterion associated with a second communication regarding the financial product; determining at least one of the plurality of segments needed to satisfy the at least one criterion; and providing the second communication to at least one member of the determined at least one of the plurality of segments. In yet another embodiment, a method for providing a communication regarding a financial product may include determining a plurality of segments, wherein each of the plurality of segments includes at least one member of a plurality of potential recipients of a communication regarding the financial product and has an associated response rate, wherein a segment's associated response rate is indicative of a member of the segment exhibiting a designated behavior after receiving the communication; determining at least one criterion associated with the communication regarding the financial product; determining at least one of the plurality of segments needed to satisfy the at least one criterion; and providing a notification regarding the at least one of the plurality of segments needed to satisfy the at least one criterion. In another embodiment, a method for providing a communication regarding a financial product may include determining a plurality of segments, wherein each of the plurality of segments includes at least one member of a plurality of potential recipients of a communication regarding a financial product and an associated score indicative of a member of the segment exhibiting a desired behavior after receiving the communication; selecting at least one of the plurality of segments to provide the communication; and providing the communication to at least one member of the determined at least one of the plurality of segments.

According to embodiments of the present invention, a system for determining a recipient of a communication regarding a financial product may include a memory; a communication port; and a processor connected to the memory and the communication port, the processor being operative to determine a plurality of segments from a plurality of potential recipients of a communication regarding a financial product, wherein each of the plurality of segments includes at least one member of the plurality of potential recipients and has an associated response rate, wherein a segment's associated response rate is indicative of a member of the segment exhibiting a designated behavior after receiving the communication; determine at least one criterion associated with the communication regarding a financial product; and determine at least one of the plurality of segments that may be used to satisfy the at least one criterion. In another embodiment, a system for determining a recipient of a communication regarding a financial product may include a memory; a communication port; and a processor connected to the memory and the communication port, the processor being operative to provide a first communication regarding a financial product to a plurality of recipients; determine a plurality of segments of the plurality of recipients, wherein each of the plurality of segments includes at least one of the plurality of recipients; determine at least one criterion associated with a second communication regarding the financial product; determine at least one of the plurality of segments needed to satisfy the at least one criterion; and provide the second communication to at least one member of the determined at least one of the plurality of segments. In a further embodiment, a system for determining a recipient of a communication regarding a financial product may include a memory; a communication port; and a processor connected to the memory and the communication port, the processor being operative to provide a first communication regarding a financial product to a plurality of recipients; determine a plurality of segments, wherein each of the plurality of segments includes at least one member of the plurality of recipients and has an associated indicative characteristic, wherein a segment's associated indicative characteristic is indicative of a member of the segment exhibiting a designated behavior after receiving the first communication; determine at least one criterion associated with a second communication regarding the financial product; determine at least one of the plurality of segments needed to satisfy the at least one criterion; and provide the second communication to at least one member of the determined at least one of the plurality of segments. In yet another embodiment, a system for providing a communication regarding a financial product may include a memory; a communication port; and a processor connected to the memory and the communication port, the processor being operative to determine a plurality of segments, wherein each of the plurality of segments includes at least one member of a plurality of potential recipients of a communication regarding the financial product and has an associated response rate, wherein a segment's associated response rate is indicative of a member of the segment exhibiting a designated behavior after receiving the communication; determine at least one criterion associated with the communication regarding the financial product; determine at least one of the plurality of segments needed to satisfy the at least one criterion; and provide a notification regarding the at least one of the plurality of segments needed to satisfy the at least one criterion. In another embodiment, a system for providing a communication regarding a financial product may include a memory; a communication port; and a processor connected to the memory and the communication port, the processor being operative to determine a plurality of segments, wherein each of the plurality of segments includes at least one member of a plurality of potential recipients of a communication regarding a financial product and an associated score indicative of a member of the segment exhibiting a desired behavior after receiving the communication; select at least one of the plurality of segments to provide the communication; and provide the communication to at least one member of the determined at least one of the plurality of segments.

According to embodiments of the present invention, a computer program product in a computer readable medium for determining at least one recipient of a communication regarding a financial product may include first instructions for identifying a plurality of segments from a plurality of potential recipients of a communication regarding a financial product, wherein each of the plurality of segments includes at least one member of the plurality of potential recipients and has an associated response rate, wherein a segment's associated response rate is indicative of a member of the segment exhibiting a designated behavior after receiving the communication; second instructions for identifying at least one criterion associated with the communication regarding a financial product; and third instructions for identifying at least one of the plurality of segments that may be used to satisfy the at least one criterion. In another embodiment, a computer program product in a computer readable medium for providing a communication regarding a financial product may include first instructions for sending a first communication regarding a financial product to a plurality of recipients; second instructions for identifying a plurality of segments of the plurality of recipients, wherein each of the plurality of segments includes at least one of the plurality of recipients; third instructions for identifying at least one criterion associated with a second communication regarding the financial product; fourth instructions for identifying at least one of the plurality of segments needed to satisfy the at least one criterion; and fifth instructions for sending the second communication to at least one member of the determined at least one of the plurality of segments. In a further embodiment, a computer program product in a computer readable medium for promoting a financial product may include first instructions for sending a first communication regarding a financial product to a plurality of recipients; second instructions for identifying a plurality of segments, wherein each of the plurality of segments includes at least one member of the plurality of recipients and has an associated indicative characteristic, wherein a segment's associated indicative characteristic is indicative of a member of the segment exhibiting a designated behavior after receiving the first communication; third instructions for identifying at least one criterion associated with a second communication regarding the financial product; fourth instructions for identifying at least one of the plurality of segments needed to satisfy the at least one criterion; and fifth instructions for sending the second communication to at least one member of the determined at least one of the plurality of segments. In yet another embodiment, a computer program product in a computer readable medium for providing a communication regarding a financial product may include first instructions for identifying a plurality of segments, wherein each of the plurality of segments includes at least one member of a plurality of potential recipients of a communication regarding the financial product and has an associated response rate, wherein a segment's associated response rate is indicative of a member of the segment exhibiting a designated behavior after receiving the communication; second instructions for identifying at least one criterion associated with the communication regarding the financial product; third instructions for identifying at least one of the plurality of segments needed to satisfy the at least one criterion; and fourth instructions for sending a notification regarding the at least one of the plurality of segments needed to satisfy the at least one criterion. In another embodiment, a computer program product in a computer readable medium for providing a communication regarding a financial product may include first instructions for identifying determining a plurality of segments, wherein each of the plurality of segments includes at least one member of a plurality of potential recipients of a communication regarding a financial product and an associated score indicative of a member of the segment exhibiting a desired behavior after receiving the communication; second instructions for identifying at least one of the plurality of segments to provide the communication; and third instructions for sending the communication to at least one member of the determined at least one of the plurality of segments.

According to embodiments of the present invention, an apparatus for determining at least one recipient of a communication regarding a financial product may include means for identifying a plurality of segments from a plurality of potential recipients of a communication regarding a financial product, wherein each of the plurality of segments includes at least one member of the plurality of potential recipients and has an associated response rate, wherein a segment's associated response rate is indicative of a member of the segment exhibiting a designated behavior after receiving the communication; means for identifying at least one criterion associated with the communication regarding a financial product; and means for identifying at least one of the plurality of segments that may be used to satisfy the at least one criterion. In another embodiment, an apparatus for providing a communication regarding a financial product may include means for sending a first communication regarding a financial product to a plurality of recipients; means for identifying a plurality of segments of the plurality of recipients, wherein each of the plurality of segments includes at least one of the plurality of recipients; means for identifying at least one criterion associated with a second communication regarding the financial product; means for identifying at least one of the plurality of segments needed to satisfy the at least one criterion; and means for sending the second communication to at least one member of the determined at least one of the plurality of segments. In a further embodiment, an apparatus for promoting a financial product may include means for sending a first communication regarding a financial product to a plurality of recipients; means for identifying a plurality of segments, wherein each of the plurality of segments includes at least one member of the plurality of recipients and has an associated indicative characteristic, wherein a segment's associated indicative characteristic is indicative of a member of the segment exhibiting a designated behavior after receiving the first communication; means for identifying at least one criterion associated with a second communication regarding the financial product; means for identifying at least one of the plurality of segments needed to satisfy the at least one criterion; and means for sending the second communication to at least one member of the determined at least one of the plurality of segments. In yet another embodiment, an apparatus for providing a communication regarding a financial product may include means for identifying a plurality of segments, wherein each of the plurality of segments includes at least one member of a plurality of potential recipients of a communication regarding the financial product and has an associated response rate, wherein a segment's associated response rate is indicative of a member of the segment exhibiting a designated behavior after receiving the communication; means for identifying at least one criterion associated with the communication regarding the financial product; means for identifying at least one of the plurality of segments needed to satisfy the at least one criterion; and means for sending a notification regarding the at least one of the plurality of segments needed to satisfy the at least one criterion. In another embodiment, an apparatus for providing a communication regarding a financial product may include means for identifying determining a plurality of segments, wherein each of the plurality of segments includes at least one member of a plurality of potential recipients of a communication regarding a financial product and an associated score indicative of a member of the segment exhibiting a desired behavior after receiving the communication; means for identifying at least one of the plurality of segments to provide the communication; and means for sending the communication to at least one member of the determined at least one of the plurality of segments.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a block diagram of system components for an embodiment of an apparatus usable with the methods of FIGS. 1-2;

FIG. 4 is a block diagram of components for an embodiment of a communication manager device of FIG. 3;

FIG. 5 is an illustration of a representative recipient information database of FIG. 4;

FIG. 6 is an illustration of a representative recipient device information database of FIG. 4;

FIG. 7 is an illustration of a representative segment information database of FIG. 4;

FIG. 8 is an illustration of a representative communication information database of FIG. 4;

FIG. 9 is an illustration of a representative financial product information database usable with the communication manager device of FIG. 4; and

FIG. 10 is an illustration of a representative financial product information database usable with the communication manager device of FIG. 4.

### DETAILED DESCRIPTION

Applicants have recognized that there is a need for systems, means, computer code and methods that allow communications regarding financial products to be sent to the recipients most likely to respond to the communications. Moreover, Applicants have recognized that there is a need for systems, means, computer code and methods for reducing mailing and other development or transmission costs associated with sending promotional communications to recipients and for increasing response rates associated with the recipients. A technical effect provided by the systems, means, computer code and methods described herein is that potential recipients of a promotional communication can be ranked accordingly to their likelihood of conducting, satisfying or otherwise exhibiting a desired or designated action or behavior (e.g., incremental use of a credit card, acceptance of a reissued credit card) after receiving the promotional communication, thereby allowing a systematic and analytical selection of actual recipients of the promotional communication to be made.

For purposes of discussion of the methods disclosed herein, the methods will be assumed to be conducted by an entity referred to herein as a “manager” and/or a device referred to herein as a “manager device”. The term “manager” is not intended to have any specific or limited meaning. In some embodiments, the manager may have sent the communication to the recipients. In other embodiments, a client or customer of the manager (e.g., an advertiser, a merchant) or some other party may have sent the communication to the recipients.

In some embodiments, a communication may be or include any type of advertisement, promotional or marketing material, announcement, commercial, graphic image, text message, etc. The communication may comprise, be sent in, or be part of an email message, instant message communication, banner or other electronic or Web based advertisement, letter, postcard, flyer, coupon, facsimile transmission, beeper or pager signal or transmission, HTTP, FTP, XML or HTML transmission or feed, some other electronic signal or communication, some other type of communication sent via a postal system or courier service, etc.

In some embodiments, a financial product may be or include a credit card, debit card or other financial card issued by or for the manager, or by or for one or more other entities by the manager. In some cases, the manager may provide services to other entities selling or servicing financial products, even though the manager itself does not provide or service the financial products. In some embodiments, a financial product may include a credit card or debit card branded or private labeled with a logo of a merchant, advertiser, sports organization, bank or other financial institution, etc. The term “product” as used herein shall also include services that may be provided by the manager or other entity to potential and/or actual recipients of communications.

In such embodiments, the manager may use the methods disclosed herein to determine which type, format, etc. of communication best motivates recipients to complete a desired or designated action or behavior. For example, the designated activity may be a recipient signing up to apply for, use or receive a credit card; the recipient using a previously issued credit card; the recipient getting someone else to agree to use, apply for, or accept a credit card; the recipient agreeing to use a specific debit card or bank account; etc. In some embodiments, the desired or designated activity may include a recipient of a promotional communication regarding a financial product to use the financial product in making purchases or conducting other transactions over and above the level of use the recipient would have made of the financial product if the recipient had not received the promotional communication (e.g., an incremental use of the financial product). More specially, the desired action or behavior in a recipient receiving a promotional communication may be incremental use of a credit card after the recipient receives the credit card.

Promotional communication may be sent as part of a marketing or promotional campaign for a financial product. For example, a merchant may want to promote use of a merchant branded or private labeled credit card for purchases made by recipients of a communication regarding the credit card at the merchant. Different communications may be used for different financial products. In addition, different communications may make different offers to recipients of the communications regarding one or more financial products. These and other features will be discussed in further detail below, by describing a system, individual devices, computer code, and processes according to embodiments of the invention.

Process Description

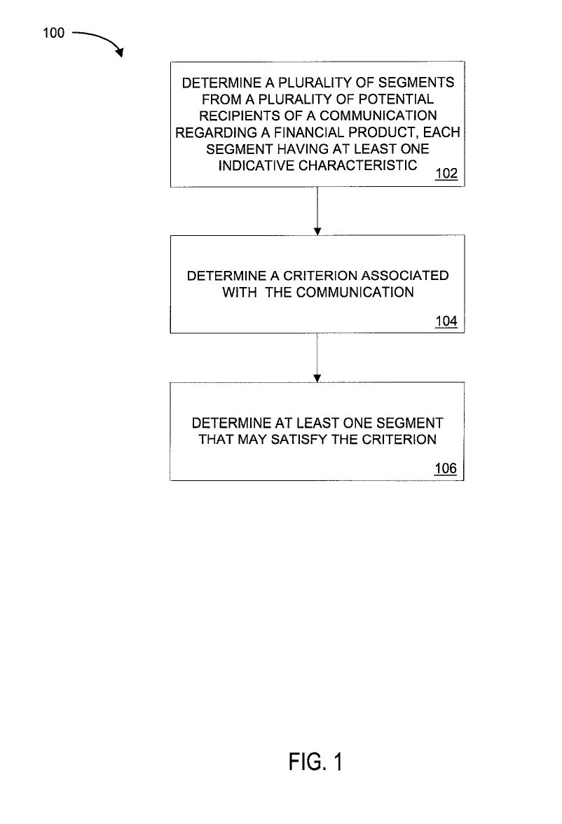

4Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a manager, server, and/or another entity or device for itself or on behalf of one or more parties, as will be discussed in more detail below. For purposes of discussion, but not limitation, of the method 100, the method 100 is assumed to be conducted by a “manager” and/or a “manager device” on behalf of itself and/or one or more other entities.

Processing begins at a step 102 during which the manager determines a plurality of segments from among a plurality of potential recipients of a communication regarding a financial product. In some embodiments, the manager may have sent one or more prior communications to some or all of the recipients. In other embodiments, a client, financial product provider, or some other party may have sent one or more prior communications to some or all of the recipients.

In some embodiments, prior to or as part of the step 102, the manager may need to identify, select or otherwise determine some or all of the plurality of recipients. The manager may keep lists of potential recipients, purchase lists of potential recipients, receive lists of potential recipients, etc. For example, a credit card issuer may want the manager to help the credit card issuer determine who to send a promotional communication to regarding a credit card brand or private label. The credit card issuer may provide to the manager a list of its current customers or users of its issued credit cards for use with the method 100. In some embodiments, information regarding one or more recipients may be stored in or accessed from a recipient information database.

A communication may promote use of a financial product by making a specific offer. For example, a communication may provide to a recipient having a credit card a ten percent discount off of all purchases made by the recipient using the credit card during a specific time period. As another example, a communication may provide to a recipient twenty dollars off the next purchase over one hundred dollars made using the financial product. As a third alternative, a communication may provide to a recipient a discount off or rebate for purchases of a specific product, specific brand of products, products bought a specific merchant, products bought during a specific time, etc.

Each of the segments determined during the step 102 will have at least one indicative characteristic. For example, the segments of recipients determined during the step 102 may be segmented according to demographic information (e.g., age, gender, income, residence, marital status, family size, nationality).

As another example of how segments may be created during the step 102, the step 102 may include grouping different potential recipients of a communication into segments based on how some or all the potential recipients responded to one or more prior communications regarding a financial product. Thus, past activities by some or all of the potential recipients may be used to select or identify the recipients of a new communication, the selected recipients being the most likely to complete or otherwise exhibit a desired action or behavior upon receiving the new communication.

A desired or designated recipient action, behavior or goal may be associated with a new communication regarding the financial product. For example, a communication may be designed to promote use of a credit card by a recipient. The desired action may be transactions or purchases made by the recipient using the credit card in response to the communication over and above what the recipient would have done without receiving the communication (e.g., an incremental purchase or transaction). The manager or some other entity or device may determine which recipients that received the communication completed or satisfied the desired action. This might be done by comparing uses of credit cards by recipients of the communication to uses of credit cards by people who did not receive the communication (i.e., a control group). From this group of recipients of the communication that completed the desired action, segments of the recipients may be created and a response rate to the communication determined. The manager may use the information to determine what recipients to send future communications.

Different groups or segments of recipients may have different response rates to a communication. For example, sixteen percent of the members of one segment may have responded to the communication while only eight percent of the members of a second segment may have responded to the communication.

In some embodiments, the manager may want to determine segments of potential recipients of a communication that have the highest likely response rate. That is, the manager may want to identify segments from among the potential recipients of a communication that are likely to have the highest response rates to the communication. Each of the segments may have identifying characteristics (e.g., age, credit history, credit card balances, numerical score or rank) that distinguish them.

One technique of determining segments that may be used during the step 102 is to determine significant variables for different segments of recipients of prior communications and generate a score for the potential recipients of a new communication indicative of response rates for the new communication based on these variables. For example, prior to or as part of the step 102, the manager may receive demographic information, lifestyle information (e.g., hobbies, preferences, spending patterns), credit history information (e.g., number of credit cards, balances of credit cards, payment delinquency, bank or other financial account balances, FICO information), and/or credit performance information (e.g., credit limit on credit card, average or current balance on credit card, transactions made using a credit card, finance charge information) for recipients of one or more prior communications. Some or all of the information may come from credit bureaus, government agencies, publicly available records, financial product sellers, credit card issuers, or other information sources or providers.

The manager may use the information in a logistic regression analysis, swap set analysis, linear programming analysis, multivariate analysis, or other data or numerical analysis to determine the most significant variables that predict a recipient's likely response to a new communication. For example, suppose the financial product involved in a communication is a credit card. The communication is sent to current possessors or users of the credit card in hopes of motivating the recipients to increase their use of the credit card to make purchases over what they would have done normally (i.e., what they would have done if they had not received the communication). For example, the communication may have offered ten percent off all purchases made using the credit card at a specific merchant (e.g., J C Penny, Walmart, Macys). The credit card even may be branded or private labeled with the merchant's name. Thus, the desired action for a recipient receiving the communication is an incremental use of the credit card by the recipients over the recipient's normal use. It may be determined via trial and error, the analysis of responses to earlier communications, numerical modeling, etc. that predicting a recipient's likelihood of response to a new communication may be found by looking at the five following predictor variables: TNUM, the number of transactions the recipient has made in the last three months using the credit card; UTIL, the current utilization of the credit card (e.g., the current balance of the credit card divided by the maximum allowed balance of the credit card); PB24 the number of months in the past twenty-four months where the recipient has a positive balance on the credit card or has used the credit card to make a purchase; MSLS, the number of months since the credit card was used to make a purchase; and AVGBAL, the average daily balance for the credit card in the past month.

A first score S1 for this offer may be generated based on the five predictor variables as follows: S1=((AVGBAL×0.000243)+(UTIL×0.08858)−(MSLS×0.2448)+(PB24×0.0521+(TNUM×0.0929)−4.5346). A final score SF for the offer may be generated as follows: SF=e^{S1}/(1+e^{S1}). The number “−4.5346” may act as a sort of bias or intercept for computing the final score for this offer. During the step 102, the manager may generate a score for each potential recipient of a new communication. Segments of recipients can be created by grouping the recipients according to their score. Thus, each segment has an indicative characteristic that is a score or score range. For example, suppose scores for 47,566 recipients of one or more prior communications regarding a credit card are computed using the formulas for S1 and SF described above. Some of the recipients had the desired response to the communication (e.g., incremental purchases with their credit cards) while others did not. Ten segments for the recipients may be generated by using the scores and breaking or segmenting the recipients into deciles, as illustrated in Table 1.

TABLE 1

| | Cumulative | | | |
|---|---|---|---|---|
| | Number of | Minimum | Maximum | |
| Decile | Recipients | Score for SF | Score for SF | Response Rate |
| 1 | 4,756 | 0.103 | 0.977 | 16.2% |
| 2 | 9.513 | 0.067 | 0.102 | 8.3% |
| 3 | 14,269 | 0.044 | 0.066 | 5.5% |
| 4 | 19,026 | 0.029 | 0.043 | 3.6% |
| 5 | 23,783 | 0.019 | 0.028 | 2.3% |
| 6 | 28,539 | 0.012 | 0.018 | 1.5% |
| 7 | 33,296 | 0.007 | 0.011 | 1.0% |
| 8 | 38,052 | 0.003 | 0.006 | 0.5% |
| 9 | 42,089 | 0.001 | 0.002 | 0.2% |
| 10 | 47,566 | | <0.001 | 0.1% |

Once recipients are broken into the ten segments based on deciles, the predicted response rates for the segments to a new communication can be determined by looking at the responses of the recipients in the segments that received prior communication(s). In some cases, a member of a segment may not have received a prior communication or may not have received the same number of communications as another member of the segment. Thus, a potential recipient may be in segment 1, for example, even though the potential recipient never received a prior communication.

Each segment illustrated in Table 1 has at least one indicative characteristic, namely, the SF score ranges associated with the segment and/or the response rate associated with the segment. Other indicative characteristics (e.g., demographic similarities) among members of a specific segment also may be determined.

As a second example, suppose the financial product involved in a communication is a credit card. For example, the communication may have offered a reissue of a credit card (i.e., a new or replacement credit card is provided) plus ten percent all purchases made at a particular merchant (e.g., Home Depot, Sears). The desired action for a recipient receiving the communication is an incremental use of the credit card by the recipients over the recipient's normal use. It may be determined via trial and error, the analysis of responses to earlier communications, numerical modeling, etc. that predicting a recipient's likelihood of response to a new communication may be found by looking at the three following predictor variables: SQRTLPUR, the square root of the total lifetime purchases made using the credit card; INVMSLS, the inverse of (1+MSLS), where MSLS is the number months since the credit card was used to make a purchase; and PYMT6, the total payments made to reduce the balance of the credit card during the past six months. INVMSLS is equal to (1/(1+MSLS)). A first score S1 for this offer may be generated based on the three predictor variables as follows: S1=((INVMSLS×1.9237)+(PYMT6×0.000133)+(SQRTLPUR×0.0127)−2.5844). A final score SF for the offer may be generated as follows: SF=e^{S1}/(1+e^{S1}). The number “−2.5844” may act as a sort of bias or intercept for computing the final score for this offer. Deciles and segmentations for scores created using the second set of predictor variables and formula can be established in a manner similar to that discussed above.

As a third example, suppose the financial product involved in a communication is a credit card. For example, the communication may have offered a reissue of a credit card (i.e., a new or replacement credit card is provided) and be branded or private labeled for or to a particular merchant (e.g., Home Depot, Sears). The desired action for a recipient receiving the communication is an incremental use of the credit card by the recipients over the recipient's normal use. It may be determined via trial and error, the analysis of responses to earlier communications, numerical modeling, etc. that predicting a recipient's likelihood of response to a new communication may be found by looking at the five following predictor variables: LPUR, the total lifetime purchases made using the credit card; PYMT3, the total payments made to reduce the balance of the credit card during the past three months; ALUTIL3, the average credit line utilization over the past three months; MXUNPF12, the maximum unpaid finance charges during the past twelve months; and SQRTNSALE12, the square root of the number of months with positive sales on the credit card during the past twelve months. A credit card's credit line utilization can be found by dividing the current balance by the maximum allowed balance. A first score S1 for this offer may be generated based on the five predictor variables as follows: S1=((SQRTNSALE12×0.9760)−(MXUNPF12×0.00414)+(ALUTIL3×1.216)+(PYMT3×0.000257)+(LIFPUR×0.000052)−3.2135). A final score SF for the offer may be generated as follows: SF=e^{S1}/(1+e^{S1}). The number “−3.2135” may act as a sort of bias or intercept for computing the final score for this offer. Deciles and segmentations for scores created using the second set of predictor variables and formula can be established in a manner similar to that discussed above.

Different formulas, predictor variables, intercepts, etc. may be developed for different offers, different merchants, different financial products, different groups of actual or potential recipients of communications, etc. In addition, predictor variables, formulas, intercepts, etc. may change over time as more customer data and communication result information is obtained and analyzed. As previously mentioned above, in some embodiments, prior to or as part of the step 102, the manager may need to identify, select or otherwise determine some or all of the plurality of recipients. In some embodiments, one or more recipients of a prior communication may be excluded from use in the predictive model for a variety of reasons. In addition, some potential recipients may be excluded from receiving a promotional communication for a variety of reasons. For example, potential recipients that fail to meet or pass other specific criteria (e.g., income level, credit risk criteria, zero available credit limit, minimum time having a credit card) may be excluded from receiving a new communication. In addition, potential recipients that have a history or likelihood of committing fraud, making delinquent payments, requiring substantial customer service assistance, etc. also may be excluded.

During a step 104, the manager may determine at least one criterion associated with the new communication that is to be sent to at least some of the potential recipients. For example, an advertiser wanting to send the communication may want to mail or email the communication to a maximum of ten thousand people having the highest likelihood of responding to the communication. According to Table 1, the advertiser may want to send the communication only to the members of the top two segments (i.e., deciles 1 and 2). Alternatively, the advertiser may want to send the communication to as many people as possible, so long as the advertiser can expect greater than a three percent response rate to the communication. According to Table 1, the advertiser may want to send the communication only to the members of the top four segments (i.e., deciles 1-4). The advertiser may need at least a three percent return rate to break even on the communication. As another example, the advertiser may want to receive a minimum number of responses to a mailing touting a financial product (i.e., a promotional communication). Fewer mailings will be required if the mailings are sent to the members of segments having the highest likelihood of responding to the mailing. As another example, the advertiser may want to get the maximum number of respondents for a designated or maximum investment in or cost of a mailing to recipients of a promotional communication. As a further example, the advertiser may establish a minimum return on investment (ROI), minimum gross marketing return (GMR), maximum risk, minimum propensity of response, minimum incremental sales result, etc. that the communication offer determined during the step 104 preferably will meet or satisfy (i.e., comply with).

In some embodiments, the manager may receive data or other communication regarding the criterion from another party. In some embodiments, the step 104 or the method 100 may include determining the criterion. Determination of a criterion may include factors such as available budget, cost of a communication, desired or actual size of a recipient pool, the number of recipients needed to respond to a communication, the number of desired respondents to a communication, etc.

During a step 106, the manager determines which segments may be sent the new communication such that the criterion determined during the step 104 is satisfied or completed.

In some embodiments, the manager may provide or send out the new communication to members of the identified segments. Alternatively, the manager may provide data or other notification regarding the segments determined during the step 106 to another entity or device that may send out the new communication. In some embodiments, the manager may determine, bill for, and/or receive compensation for conducting one or more of the steps of the method 100.

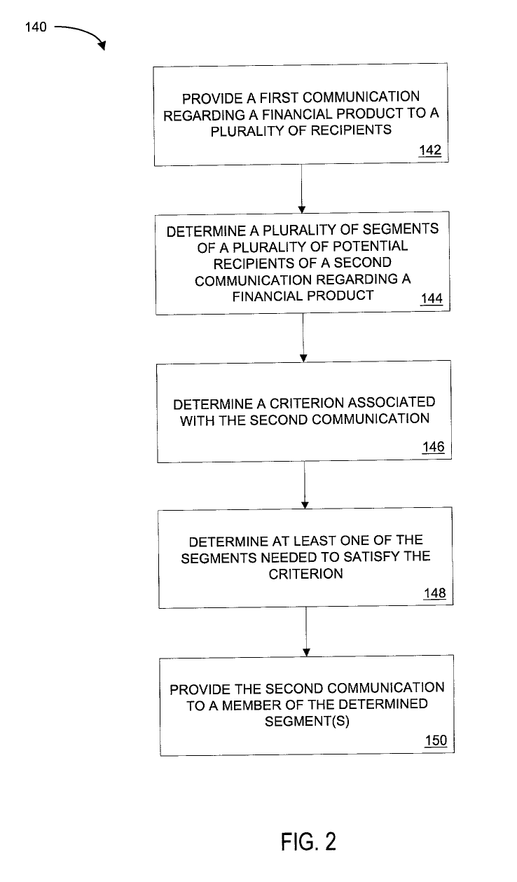

Reference is now made to FIG. 2, where a flow chart 140 is shown which represents the operation of a second embodiment of the present invention. The particular arrangement of elements in the flow chart 140 is not meant to imply a fixed order to the steps; embodiments of the present invention can be practiced in any order that is practicable. In some embodiments, some or all of the steps of the method 140 may be performed or completed by a manager, manager device and/or another entity or device. For purposes of discussion, but not limitation, of the method 100, the method 100 will be assumed to be conducted by a “manager” and/or a “manager device”. In some embodiments, the method 140 may include some or all of the variations discussed above in reference to the method 100.

Processing begins at a step 142 during which a first communication regarding a financial product is provided to a plurality of recipients. In some embodiments, activities by the recipients to the communication may be determined and compared to a control group to determine which of the recipients conducted, exhibited or satisfied a desired or designated action or behavior in response to the communication. For example, an analysis or responses by recipients of the communication may determine whether incremental uses of credit cards where made by recipients of the communication as compared to members in the control group that did not receive the communication. The analysis of the recipients also may take into account additional communications that may have been sent to some or all of the recipients.

During a step 144, a plurality of segments of the potential recipients is determined. The step 144 is similar to the step 102 previously discussed above.

During a step 146, a criterion is determined that is associated with the second communication. The step 146 is similar to the step 104 previously discussed above.

During a step 148, a segment is determined that satisfies the criterion determined during the step 146. The step 148 is similar to the step 106 previously discussed above.

During a step 150, the second communication is provided to at least one member of at least one of the segments determined during the step 148. In some embodiments, the second communication may have a similar style, format, content, delivery channel, etc. as the first communication. In other embodiments, the second communication may have a style, format, content, delivery channel, etc. than the first communication. When the first communication and the second communication are different, different response rates to the second communication may occur than are predicted as a result of variances of different recipients to the different second communication. Thus, in some embodiments, the methods disclosed herein may be more effective when used to predict responses to new communications that are similar to previous communications.

Other variations and embodiments of the methods disclosed above are also possible. For example, in some embodiments, a method for promoting a financial product or for determining at least one recipient to send a promotional communication may include providing a first communication regarding a financial product to a plurality of recipients; determining a plurality of segments, wherein each of the plurality of segments includes at least one member of the plurality of recipients and has an associated indicative characteristic, wherein a segment's associated indicative characteristic is indicative of a member of the segment exhibiting a designated behavior after receiving the first communication; determining at least one criterion associated with a second communication regarding the financial product; determining at least one of the plurality of segments needed to satisfy the at least one criterion; and providing the second communication to at least one member of the determined plurality of segments.

In another embodiment, a method for providing a communication regarding a financial product or for identifying at least one desired recipient of the communication may include determining a plurality of segments or potential recipients, wherein each of the plurality of segments includes at least one member of a plurality of potential recipients of a communication regarding the financial product and has an associated response rate, wherein a segment's associated response rate is indicative of a member of the segment exhibiting a designated behavior after receiving the communication; determining at least one criterion associated with the communication regarding the financial product; determining at least one of the plurality of segments needed to satisfy the at least one criterion; and providing a notification regarding the at least one of the plurality of segments needed to satisfy the at least one criterion. The method also may include providing the communication to at least one member of a determined segment.

In a still further embodiment, a method for providing a communication regarding a financial product may include determining a plurality of segments, wherein each of the plurality of segments includes at least one member of a plurality of potential recipients of a communication regarding a financial product and an associated score indicative of a member of the segment exhibiting a desired behavior after receiving the communication; selecting at least one of the plurality of segments to provide the communication; and providing the communication to at least one member of the determined plurality of segments.

System

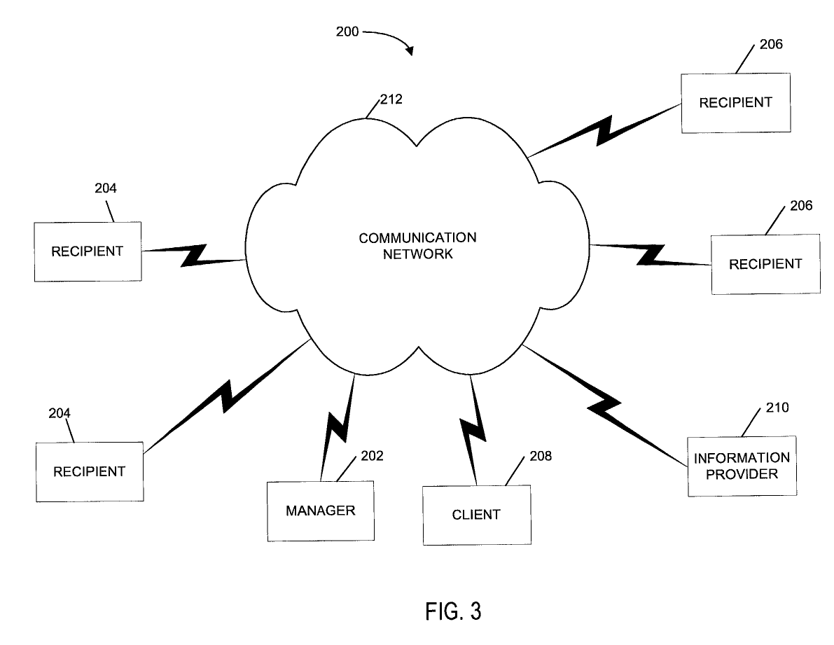

Now referring to FIG. 3, an apparatus or system 200 usable with the methods disclosed herein is illustrated. The apparatus 200 includes a manager or manager device 202 that may communicate directly or indirectly with one or more recipients 204, 206, clients 208 and information providers 210 via a computer, data, or communications network 212. For purposes of further explanation and elaboration of the methods disclosed herein, the methods disclosed herein will be assumed to be operating on, or under the control of, the manager or manager device 202.

In some embodiments, the manager or manager device 202 may implement one or more of the methods disclosed herein on behalf of one or more clients 208, which may be an advertiser, company desiring a promotional mailing, etc. In some embodiments, the manager or manager device may issue credit cards or sell other financial products or manage the sale and operation of the financial products for a client 208.

In some embodiments, a manager or manager device 202 may receive information regarding accounts, recipients, communications, etc. from an information provider. For example, the information provider 210 may be or include a credit bureau, government agency, merchant, credit card issuer, financial product seller, credit or transaction settlement company, bank, etc. that may supply information for use with the methods disclosed herein.

A manager device 202 may implement or host a Web site. A manager device 202 can comprise a single device or computer, a networked set or group of devices or computers, a workstation, etc. The use, configuration and operation of servers will be discussed in more detail below.

The recipient or client devices 204, 206 preferably allow entities to interact with the manager device 202 and the remainder of the apparatus 200. The recipient devices 204, 206 also may enable a user to access Web sites, software, databases, etc. If desired, the recipient devices 204, 206 also may be connected to or otherwise in communication with other devices. Possible recipient devices include a personal computer, portable computer, mobile or fixed user station, workstation, network terminal or server, cellular telephone, kiosk, dumb terminal, personal digital assistant, etc. Recipients may receive communications via recipient devices from the manager 202, the client 208, etc.

Many different types of implementations or hardware configurations can be used in the system 200 and with the methods disclosed herein and the methods disclosed herein are not limited to any specific hardware configuration for the system 200 or any of its components.

The communications network 212 might be or include the Internet, the World Wide Web, or some other public or private computer, cable, telephone, client/server, peer-to-peer, or communications network or intranet, as will be described in further detail below. The communications network 212 illustrated in FIG. 3 is meant only to be generally representative of cable, computer, radio, telephone, peer-to-peer or other communication networks for purposes of elaboration and explanation of the present invention and other devices, networks, etc. may be connected to the communications network 212 without departing from the scope of the present invention. The communications network 212 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a manager device 202 without departing from the scope of the present invention. Moreover, as used herein, communications include those enabled by wired or wireless technology.

The devices shown in FIG. 3 need not be in constant communication. For example, the manager device 202 may communicate with a recipient only when such communication is appropriate or necessary.

Manager Device

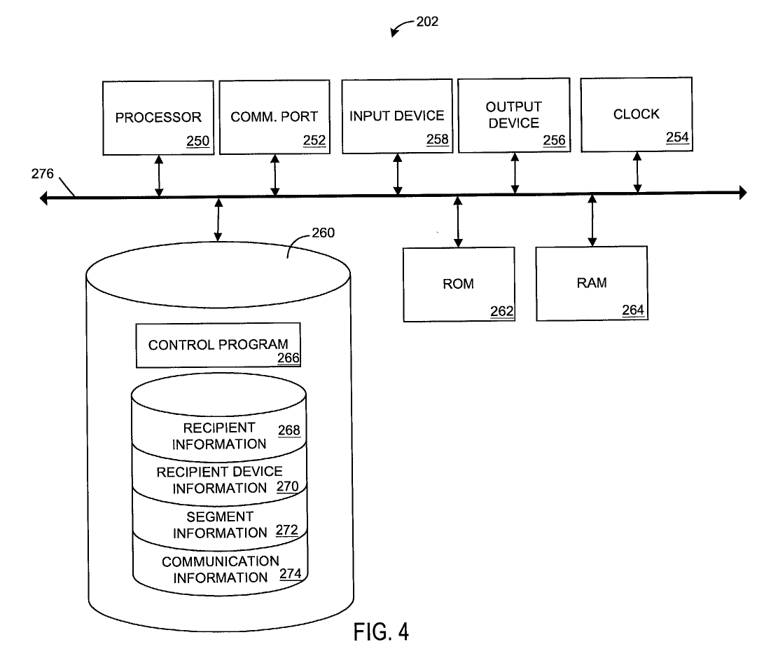

Now referring to FIG. 4, a representative block diagram of a manager device (also referred to as a server or controller 204) is illustrated. The manager device 202 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The manager device 202 also may include an internal clock element 254 to maintain an accurate time and date for the manager device 202, create time stamps for communications received or sent by the manager device 202, etc.

If desired, the manager device 202 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the manager device 202 may include a memory or data storage device 260 to store information, software, databases, communications, device drivers, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The manager device 202 also may include separate ROM 262 and RAM 264.

The processor 250 and the data storage device 260 in the manager device 202 each may be, for example: (i) located entirely within a single computer or other computing device; or (ii) connected to each other by a remote communication medium, such as a serial port cable, telephone line or radio frequency transceiver. In one embodiment, the manager device 202 may comprise one or more computers that are connected to a remote server computer for maintaining databases.

A conventional personal computer or workstation with sufficient memory and processing capability may be used as the manager device 202. In one embodiment, the manager device 202 operates as or includes a Web server for an Internet environment. The manager device 202 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the manager device 202. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The manager device 202 also may include or store information regarding recipients, communications, information providers, clients, financial products, accounts, segments, recipient devices, etc. For example, information regarding one or more recipients may be stored in a recipient information database 268 for use by the manager device 202 or another device or entity, information regarding one or more recipient devices may be stored in a recipient device information database 270 for use by the manager device 202 or another device or entity, information regarding one or more segments may be stored in a segment information database 272 for use by the manager device 202 or another device or entity, information regarding one or more communications may be stored in a communication information database 274, information regarding one or more financial products may be stored in a financial product information database (not shown), information regarding one or more accounts may be stored in an account information database (not shown), etc.

In some embodiments, some or all of one or more of the databases may be stored or mirrored locally and/or remotely from the manager device 202.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 276.

While specific implementations and hardware configurations for a communication manager device 202 have been illustrated, it should be noted that other implementations and hardware configurations are possible and that no specific implementation or hardware configuration is needed. Thus, not all of the components illustrated in FIG. 4 may be needed for a device implementing the methods disclosed herein. Therefore, many different types of implementations or hardware configurations can be used in the system 200 and the methods disclosed herein are not limited to any specific hardware configuration.

Recipient Device

As mentioned above, a recipient device 204, 206 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a recipient device 204, 206 may have the same structure or configuration as the manager device 202 illustrated in FIG. 4 and include some or all of the components of the manager device 202.

Databases

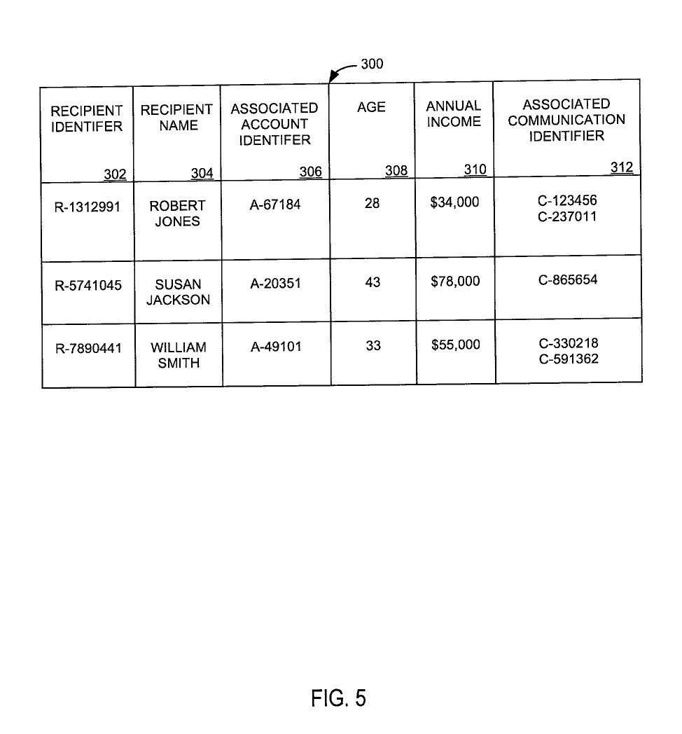

As previously discussed above, in some embodiments the manager device 202, a recipient device, or other device or entity may include or access a recipient information database for storing or keeping information regarding one or more recipient. One representative recipient information database 300 is illustrated in FIG. 5.

The recipient information database 300 may include a recipient identifier field 302 that may include codes or other identifiers for one or more recipient, a recipient name field 304 that may includes names or other information associated with the recipients identified in the field 302, an associated account identifier field 306 that may include codes or other identifiers of accounts associated with the recipients identified in the field 302, an age field 308 that may include age information for the recipients identified in the field 302, an annual income field 310 that may include information regarding the annual incomes of the recipients identified in the field 302, and an associated communication identifier field 312 that may include codes or other identifiers for communications sent or provided to the recipients identified in the field 302.

Other or different fields also may be used in the recipient information database 300. For example, in some embodiments a recipient information database may include contact information, additional or different demographic information (e.g., sex, height, race, nationality, family size, marital status, residence, place of birth), employment information, hobby or preference information, contact information (e.g., email address, telephone number, postal address), credit history information, lifestyle information, spending history information, associated recipient device information, etc. associated with recipients.

As illustrated by the recipient information database 300 of FIG. 5, the recipient identified as “R-1312991” in the field 302 is named “ROBERT JONES” and is twenty-eight years old with an annual income of “$34,000”. The recipient identified as “R-1312991 ” is associated with the account identified as “A-67184” and the communications identified as “C-123456” and “C-237011”.

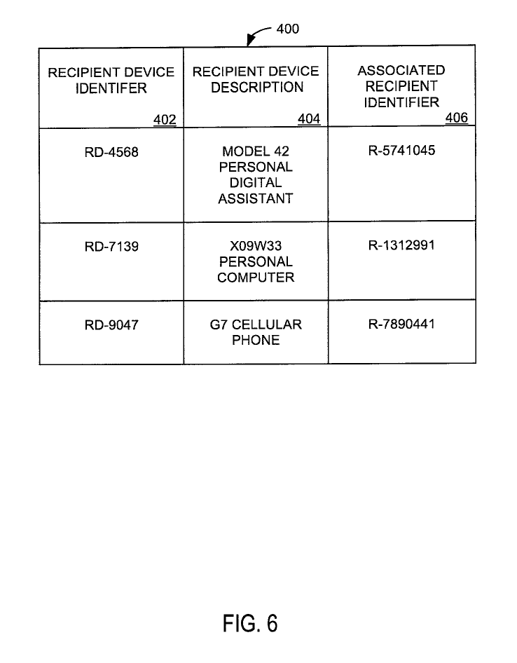

As previously discussed above, in some embodiments the manager device 202, a recipient device or other entity or device may include or access a recipient device information database for storing or keeping information regarding one or more recipient devices. One representative recipient device information database 400 is illustrated in FIG. 6.

The recipient device information database 400 may include a recipient device identifier field 402 that may include codes or other identifiers for one or more recipient devices, a recipient device description field 404 that may include names, model numbers, manufacturer names, etc. for the recipient devices identified in the field 402, and an associated recipient identifier field 406 that may include codes or other identifiers for recipients associated with the recipient devices identified in the field 402.

Other or different fields also may be used in the recipient device information database 400. For example, in some embodiments a recipient device information database may include information regarding performance, configuration, settings, options, costs, training requirements, capabilities, etc. for the recipient devices identified in the field 402.

As illustrated by the recipient device information database 400 of FIG. 6, the recipient device identified as “RD-4568” in the field 402 is a “MODEL 42 PERSONAL DIGITAL ASSISTANT” and is associated with the recipient identified as “R-5741045”.

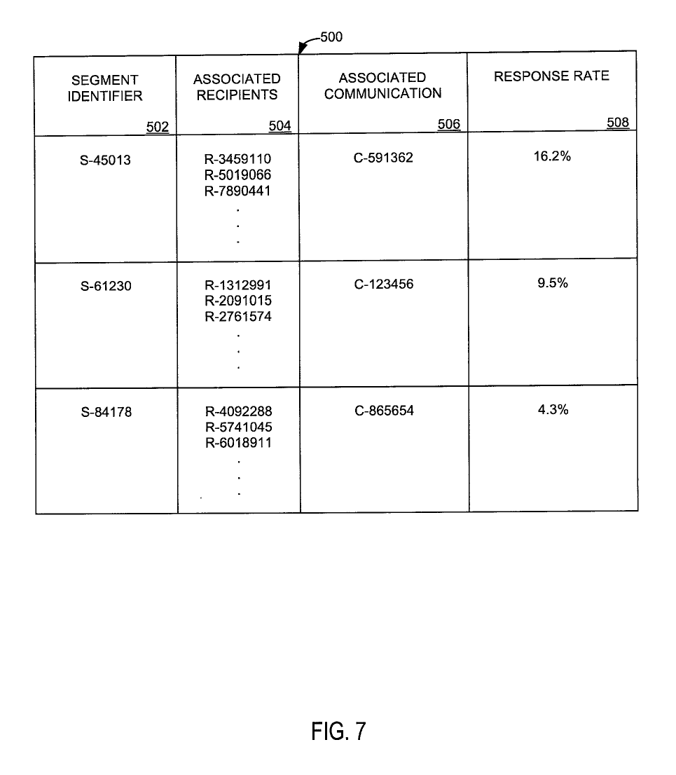

As previously discussed above, in some embodiments a server, user device, or other device may include or access a segment information database for storing or keeping information regarding one or more segments of actual or potential recipients of communications. One representative segment information database 500 is illustrated in FIG. 7.

The segment information database 500 may include a segment identifier field 502 that may include codes or other identifiers for one or more segments, an associated recipients field 504 that may include codes or other identifiers for recipients associated with the segments identified in the field 502, an associated communication field 506 that may include codes or other identifiers for communications associated with the segments identified in the field 502, and a response rate field 508 that may include information regarding response rates associated with the segments identified in the field 502 and the associated communications identified in the field 506.

Other or different fields also may be used in the segment information database 500. For example, in some embodiments a segment information database may include information regarding establishment dates for segments, indicative characteristics for segments, scores associated with segments, etc.

As illustrated by the segment information database 500 of FIG. 7, the segment identified as “S-45013” in the field 502 is associated with the recipients identified as “R-3459110”, “R-5019066”, “R-7890441”, etc. and the communication identified as “C-591362”. The segment “S-45013” had a response rate of “16.2%” for the communication “C-591362”. Note that a recipient may be associated with more than one communication, more than one financial product, and more than one segment. Similarly, a financial product may be associated with more than one communication, and vice versa. For ease of explanation, not all of the recipients identified in the field 504 of the segment information database are listed in the recipient information database 300 of FIG. 5.

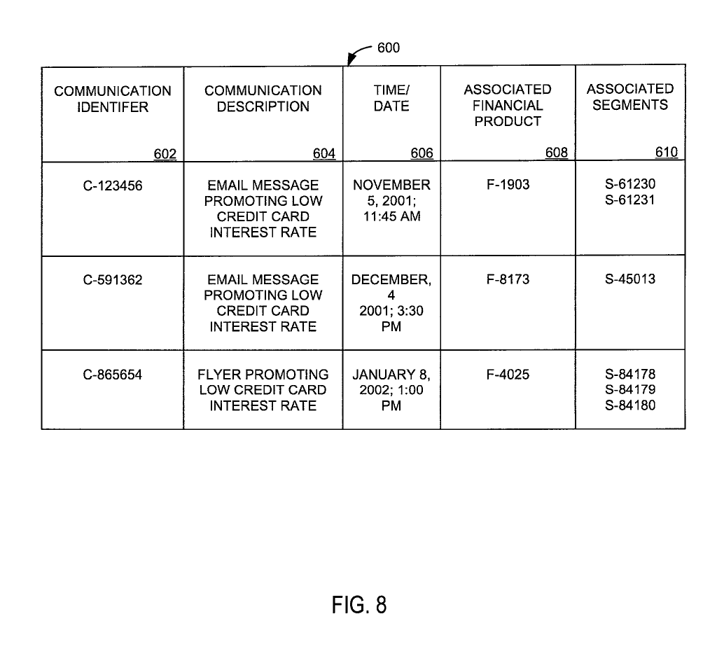

As previously discussed above, in some embodiments the manager device 202, a recipient device, or other entity or device may include or access a communication information database for storing or keeping information regarding one or more communications. One representative communication information database 600 is illustrated in FIG. 8.

The communication information database 600 may include a communication identifier field 602 that may include codes or other identifiers for one or more communications, a communication description field 604 that may include descriptive information regarding the communications identified in the field 602, a time/date field that may include information regarding the time and date of the communications identified in the field 602, an associated financial product field 608 that may include codes or other identifiers for one or more financial products associated with the communications identified in the field 602, and an associated segments field 610 that may includes codes or other identifiers for segments associated with the communications identified in the field 602.

Other or different fields also may be used in the communication information database 600. For example, in some embodiments a communication information database may include information regarding advertisers, clients, etc. associated with the communication, information regarding confirmations associated with communications, information regarding the size, cost, sophistication, etc. of communications, delivery status information for communications, etc.

As illustrated by the communication information database 600 of FIG. 8, the communication identified as “C-591362” in the field 602 is an “EMAIL MESSAGE PROMOTING LOW CREDIT CARD INTEREST RATE” and was sent on Dec. 4, 2001, to members of the segment identified as “S-45013”. The communication “C-591362” is associated with the financial product identified as “F-8173”. For ease of explanation, not all of the segments identified in the field 610 of the communication information database are listed in the segment information database 500 of FIG. 7.

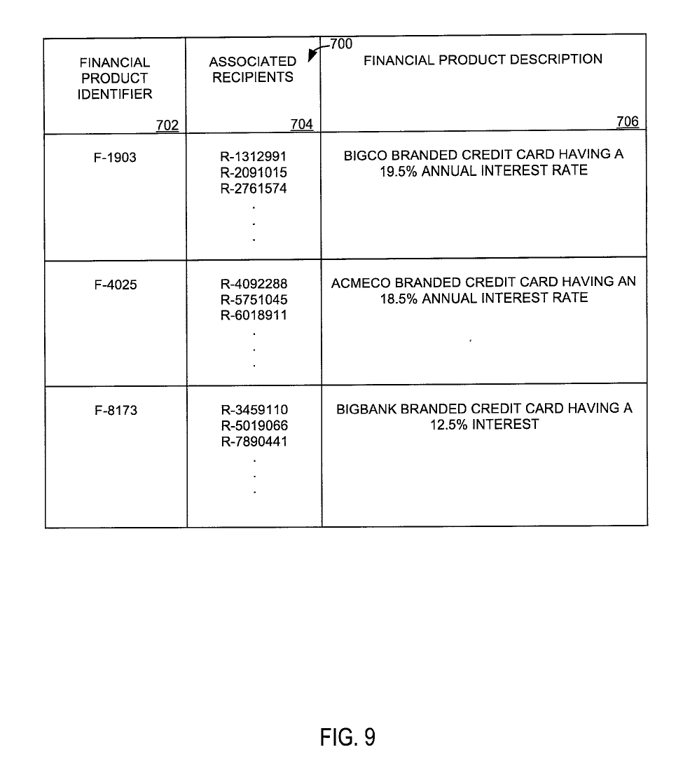

As previously discussed above, in some embodiments the manager device 202, a recipient or other entity or device may include or access a financial product information database for storing or keeping information regarding one or more financial product. One representative financial product information database 700 is illustrated in FIG. 9.

The financial product information database 700 may include a financial product identifier field 702 that may include codes or other identifiers for one or more financial products, an associated recipients field 704 that may include codes or other identifiers of recipients how have or use the financial products identified in the field 702, and a financial product description field 706 that may include descriptive information regarding the financial products identified in the field 702.

Other or different fields also may be used in the financial product information database 700. For example, in some embodiments a financial product information database may include information regarding dates when financial products became available, information regarding numbers of users or purchases of the financial products, information regarding finance charges due or paid finance charges associated with the financial products, information regarding credit line utilizations or average credit line utilizations for the financial products, information regarding lifetime purchases made via the financial products, information regarding frequency of purchases, payments, delinquencies, etc. associated with the financial products, information regarding any special privileges or statuses associated with the financial products, etc.

As illustrated by the financial product information database 700 of FIG. 9, the financial product identified as “F-1903” in the field 702 is used by the recipients identified as “R-1312991”, “R-2091015”, “R-2761574”, etc. and is a “BIGCO BRANDED CREDIT CARD HAVING A 19.5% ANNUAL INTEREST RATE”. For ease of explanation, not all of the recipients identified in the field 704 of the segment information database are listed in the recipient information database 300 of FIG. 5.

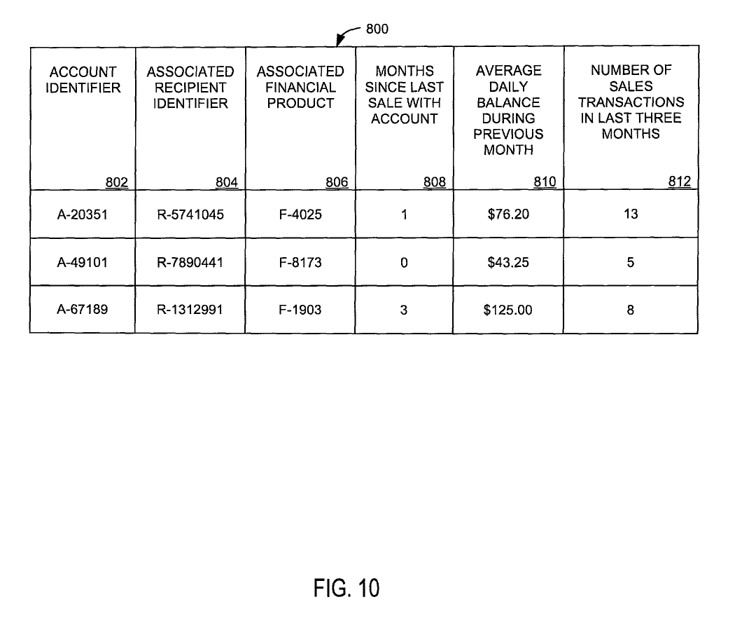

As previously discussed above, in some embodiments a server, user device, or other device may include or access an account information database for storing or keeping information regarding one or more accounts. One representative account information database 800 is illustrated in FIG. 10.

The account information database 800 may include an account identifier field 802 that may include codes or other identifiers for one or more accounts, an associated recipient field 804 that may include codes or other identifiers for recipients associated with the accounts identified in the field 802, an associated financial products field 806 that may include codes or other identifiers for financial products associated with the accounts identified in the field 802, a months since last sale field 808 that may include information regarding the last time the account was used by a recipient to make a purchase, an average daily balance field 810 that may include information regarding the average balance of the accounts identified in the field 802 during a time period (e.g., one month), and a number of sales transactions field 812 that may include information regarding the number of transactions made using the accounts identified in the field 802 during a time period (e.g., three months).

Other or different fields also may be used in the account information database 700. For example, in some embodiments an account information database may include information the number of months accounts have had positive balances, information regarding payments made by recipients to accounts, information regarding the time, place and goods or services for transactions associated with the accounts, information regarding finance charges due or paid finance charges associated with the accounts, information regarding credit line utilizations or average credit line utilizations for the accounts, information regarding lifetime purchases made via financial products associated with the accounts, information regarding payments made to the accounts, information regarding frequency of purchases, payments, delinquencies, etc. associated with the accounts, information regarding any special privileges or statuses associated with the accounts, etc.

As illustrated by the account information database 800 of FIG. 10, the account identified as “A-20351” in the field 802 is associated with the recipient identified as “R-5741045” and the financial product identified as “F-4025”. There has been at least one month since the last sale using the account “A-20351” and the average daily balance for the account is “$76.20”. There have been thirteen sales transactions during the previous three months using the account “A-20351”.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for identifying recipients of a communication regarding a financial product, comprising:
determining a plurality of segments from a plurality of potential recipients of a communication regarding a financial product, wherein each of said plurality of segments includes at least one member of said plurality of potential recipients and has an associated response rate, wherein a segment's associated response rate is indicative of a member of said segment exhibiting a designated behavior after receiving said communication;
determining at least one criterion associated with said communication regarding a financial product; and
determining at least one of said plurality of segments that may be used to satisfy said at least one criterion.

2. The method of claim 1, wherein said determining a plurality of segments from a plurality of potential recipients of a communication regarding a financial product includes at least one of the following:
receiving demographic information regarding at least one of said plurality of potential recipients;
receiving credit history information regarding at least one of said plurality of potential recipients;
receiving lifestyle information regarding at least one of said plurality of potential recipients; and
receiving credit performance information regarding at least one of said plurality of potential recipients.

3. The method of claim 1, wherein said determining a plurality of segments from a plurality of potential recipients of a communication regarding a financial product includes at least one of the following:
determining a score for at least one of said plurality of potential recipients based on designated variables, said score being indicative of said at least one of said plurality of potential recipients exhibiting said designated behavior; and
determining responses by at least some of said plurality of potential recipients to at least one previous communication regarding said financial product.

4. The method of claim 1, wherein said determining at least one criterion associated with said communication regarding a financial product includes receiving data indicative of said at least one criterion.

5. The method of claim 1, wherein said determining at least one of said plurality of segments that may satisfy said at least one criterion includes at least one of the following:
selecting segments that provide a response rate required by said at least one criterion;
selecting segments that provide a recipient pool size required by said at least one criterion; and
selecting segments of members to which said communication can be sent for a cost less than a maximum cost required by said at least one criterion.

6. The method of claim 1, further comprising:
determining a response rate for at least one of said plurality of segments.

7. The method of claim 1, further comprising:
determining an indicative characteristic for at least one of said plurality of segments.

8. The method of claim 1, further comprising:
providing said communication.

9. The method of claim 1, further comprising:
providing a notification regarding at least one of said plurality of segments that may satisfy said at least one criterion.

10. The method of claim 1, wherein said communication comprises at least one of the following:
an email message;
an instant message communication;
a letter;
an electronic signal; and
a message sent to a postal address.

11. The method of claim 1, further comprising:
determining said at least one criterion.

12. The method of claim 1, further comprising:
determining said designated behavior.

13. The method of claim 1, wherein said designated behavior includes at least one of the following:
use of said financial product;
incremental use of said financial product;
purchase of a product with said financial product;
signing up for a credit card; and
agreeing to accept a credit card.

14. The method of claim 1, wherein said designated behavior includes at least one of the following:
incremental use of said financial product over non-recipients of said communication.

15. The method of claim 1, wherein said financial product includes at least one of the following:
a credit card; and
a debit card.

16. The method of claim 1, further comprising:
determining information regarding at least one of said plurality of potential recipients.

17. The method of claim 16, wherein said determining information regarding at least one of said plurality of recipients includes at least one of the following:
receiving a list of at least two of said plurality of potential recipients;
receiving demographic information regarding at least one of said plurality of potential recipients;
receiving credit history information regarding at least one of said plurality of potential recipients;
receiving lifestyle information regarding at least one of said plurality of potential recipients; and
receiving credit performance information regarding at least one of said plurality of potential recipients.

18. The method of claim 1, further comprising:
determining use by at least one of said plurality of potential recipients of said financial product.

19. The method of claim 1, wherein said at least one criterion includes at least one of the following:
a desired minimum response rate to said communication;
a desired minimum recipient pool size;
a desired maximum recipient pool size; and
a maximum allowable cost associated with said communication.

20. The method of claim 1, further comprising:
determining said plurality of potential recipients.

21. The method of claim 1, further comprising:
selecting said communication.

22. The method of claim 1, wherein said communication includes an offer regarding said financial product.

23. A method for providing a communication regarding a financial product, comprising:
providing a first communication regarding a financial product to a plurality of recipients;
determining a plurality of segments of said plurality of recipients, wherein each of said plurality of segments includes at least one of said plurality of recipients;
determining at least one criterion associated with a second communication regarding said financial product;
determining at least one of said plurality of segments needed to satisfy said at least one criterion; and
providing said second communication to at least one member of said determined at least one of said plurality of segments.

24. The method of claim 23, wherein said providing a first communication regarding a financial product to a plurality of recipients includes at least one of the following:
emailing said first communication to at least one of said plurality of recipients;
mailing said first communication to at least one of said plurality of recipients;
sending said first communication to at least one of said plurality of recipients via an instant message communication;
sending said first communication to at least one of said plurality of recipients via a wireless transmission; and
sending said first communication to at least one of said plurality of recipients via and email message.

25. The method of claim 23, wherein said providing said second communication to at least one member of said determined at least one of said plurality of segments includes at least one of the following:
emailing said second communication to at least one of said plurality of recipients;
mailing said second communication to at least one of said plurality of recipients;
sending said second communication to at least one of said plurality of recipients via an instant message communication;
sending said second communication to at least one of said plurality of recipients via a wireless transmission; and
sending said second communication to at least one of said plurality of recipients via an email message.

26. The method of claim 23, further comprising:
selecting said first communication.

27. The method of claim 23, further comprising:
selecting said second communication.

28. The method of claim 23, further comprising:
determining a characteristic indicative of at least one of said plurality of segments.

29. The method of claim 23, wherein a segment includes a person in said plurality of recipients that has an indicative characteristic associated with said segment.

30. A method for promoting a financial product, comprising:
providing a first communication regarding a financial product to a plurality of recipients;
determining a plurality of segments, wherein each of said plurality of segments includes at least one member of said plurality of recipients and has an associated indicative characteristic, wherein a segment's associated indicative characteristic is indicative of a member of said segment exhibiting a designated behavior after receiving said first communication;
determining at least one criterion associated with a second communication regarding said financial product;
determining at least one of said plurality of segments needed to satisfy said at least one criterion; and
providing said second communication to at least one member of said determined at least one of said plurality of segments.

31. A method for providing a communication regarding a financial product, comprising:
determining a plurality of segments, wherein each of said plurality of segments includes at least one member of a plurality of potential recipients of a communication regarding said financial product and has an associated response rate, wherein a segment's associated response rate is indicative of a member of said segment exhibiting a designated behavior after receiving said communication;
determining at least one criterion associated with said communication regarding said financial product;
determining at least one of said plurality of segments needed to satisfy said at least one criterion; and
providing a notification regarding said at least one of said plurality of segments needed to satisfy said at least one criterion.

32. The method of claim 31, further comprising:
providing said communication to at least one member of said determined at least one of said plurality of segments.

33. A method for providing a communication regarding a financial product, comprising:
determining a plurality of segments, wherein each of said plurality of segments includes at least one member of a plurality of potential recipients of a communication regarding a financial product and an associated score indicative of a member of said segment exhibiting a desired behavior after receiving said communication;
selecting at least one of said plurality of segments to provide said communication; and
providing said communication to at least one member of said determined at least one of said plurality of segments.

34. A system for determining a recipient of a communication regarding a financial product, comprising:
a memory;
a communication port; and
a processor connected to said memory and said communication port, said processor being operative to
determine a plurality of segments from a plurality of potential recipients of a communication regarding a financial product, wherein each of said plurality of segments includes at least one member of said plurality of potential recipients and has an associated response rate, wherein a segment's associated response rate is indicative of a member of said segment exhibiting a designated behavior after receiving said communication;
determine at least one criterion associated with said communication regarding a financial product; and
determine at least one of said plurality of segments that may be used to satisfy said at least one criterion.

35. A computer program product in a computer readable medium for determining at least one recipient of a communication regarding a financial product, comprising:
first instructions for identifying a plurality of segments from a plurality of potential recipients of a communication regarding a financial product, wherein each of said plurality of segments includes at least one member of said plurality of potential recipients and has an associated response rate, wherein a segment's associated response rate is indicative of a member of said segment exhibiting a designated behavior after receiving said communication;
second instructions for identifying at least one criterion associated with said communication regarding a financial product; and
third instructions for identifying at least one of said plurality of segments that may be used to satisfy said at least one criterion.
